(19) United States
(12) Patent Application Publication
(10) Pub. No.: US 2019/0201990 A1
(43) Pub. Date: Jul. 4, 2019

(54) BALL CUTTER

(71) Applicant: JI ZHUN PRECISION INDUSTRY (HUI ZHOU) CO., LTD., Huizhou (CN)

(72) Inventors: LONG XU, Shenzhen (CN); YI-MIN JIANG, Shenzhen (CN); JUN-QI LI, Shenzhen (CN)

(21) Appl. No.: 16/213,821

(22) Filed: Dec. 7, 2018

(30) Foreign Application Priority Data
Sep. 27, 2018 (CN) 201811134219.5

(51) Int. Cl. B23C 5/10

(52) U.S. Cl. CPC B23C 5/1009

(57) ABSTRACT

A ball cutter includes a cutter bar and a cutter head. The cutter head has one end mounted to the cutter bar. The cutter head includes a main body and a number of cutter teeth mounted on the main body. A quantity of the cutter teeth is equal to a positive integer within a range from 8 to D*15. D is equal to a diameter of the main body of the cutter head in millimeters.

### FIELD

The subject matter herein generally relates to cutter teeth, and more particularly to a ball cutter.

### BACKGROUND

Cutting devices for processing hard and brittle materials, such as graphite, ceramic, glass, carbon fiber, and hard alloy, generally use diamond blades. However, cutting devices generally have a low number of blades which results in coarse processing and a short longevity of the cutting device.

### BRIEF DESCRIPTION OF THE DRAWINGS

Implementations of the present disclosure will now be described, by way of embodiments, with reference to the attached figures.

FIG. 1 is a partial isometric view of an embodiment of a ball cutter.

FIG. 2 is a side view of the ball cutter in FIG. 1.

FIG. 3 is a top view of the ball cutter in FIG. 1.

FIG. 4 is a diagram of a first embodiment of a cutter tooth of the ball cutter.

FIG. 5 is a diagram of a second embodiment of a cutter tooth of the ball cutter.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

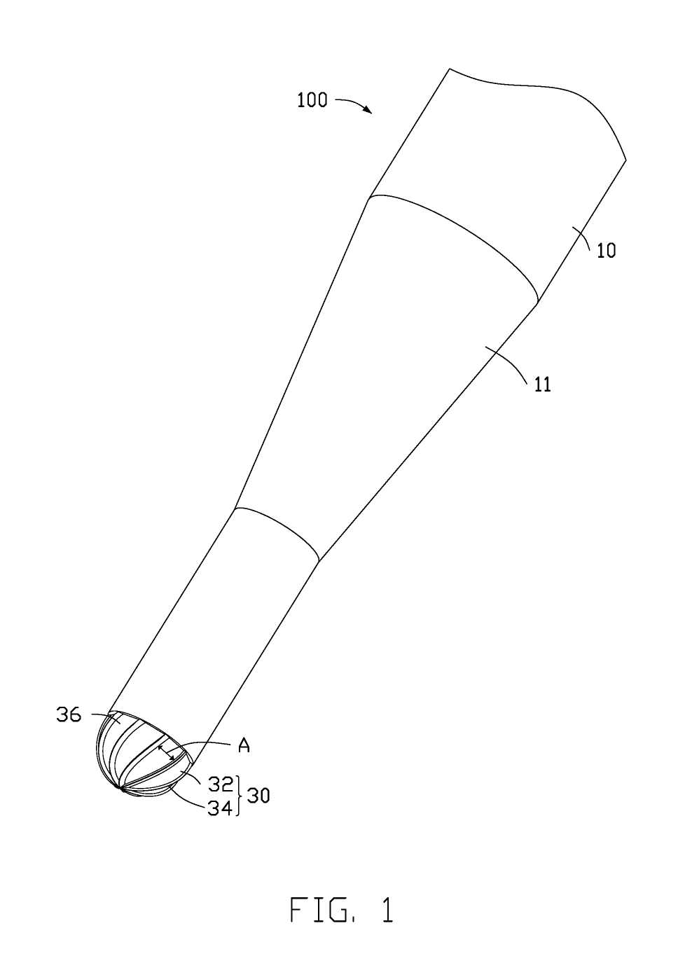

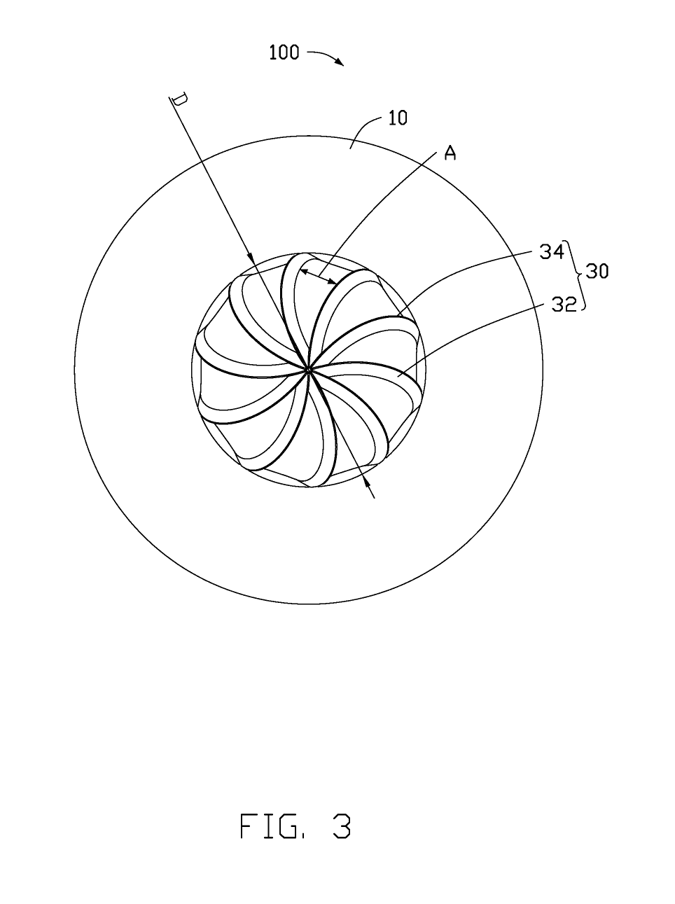

FIGS. 1-3 show an embodiment of a ball cutter 100 for processing a work piece. The ball cutter 100 includes a cutter bar 10 and a cutter head 30. The cutter head 30 is mounted to an end of the cutter bar 10.

The cutter bar 10 is externally coupled to a processing device (not shown in figures) for driving the ball cutter 100 to move and rotate. The cutter bar 10 is substantially cylindrical. In one embodiment, the cutter bar 10 includes a neck portion 11. The neck portion 11 is coupled to the cutter head 30. A diameter of the neck portion 11 coupled to the cutter head 30 is less than a diameter of the cutter bar 10 coupled to the processing device. The cutter bar 10 is made of hard alloy, high-speed steel, or the like.

The cutter head 30 is coupled to the end of the cutter bar 10. The cutter head 30 may be made of diamond, polycrystalline diamond, chemical vapour diamond, microcrystalline diamond, polycrystalline cubic boron nitride, or ceramic.

The cutter head 30 includes a main body 32 and a plurality of cutter teeth 34. The main body 32 is substantially hemispherical and includes a hemispherical peripheral wall 321 and a planar end wall 323. The planar end wall 323 is mounted to the end of the cutter bar 10. In one embodiment, the end wall 323 is welded to the cutter bar 10. An apex of the hemispherical peripheral wall 321 is on an axis of the cutter bar 10.

The plurality of cutter teeth 34 are spaced apart on the hemispherical peripheral wall 321 and are adapted for cutting a workpiece. Each cutter tooth 34 has a first end on the apex of the hemispherical peripheral wall 323 and a second end coupled to a junction of the peripheral wall 321 and the planar end wall 323.

A quantity of the plurality of cutter teeth 34 is a positive integer in a range between 8 and D*15. D is a diameter of the main body 32 of the cutter head 30 in millimeters. In one embodiment, the quantity of the plurality of cutter teeth 34 is equal to 10.

Every two adjacent cutter teeth 34 cooperatively define a groove 36. A groove width A of the groove 36 is between 0.01 and 2.0 millimeters. A base of the groove 36 may be a curved surface or may be a flat surface.

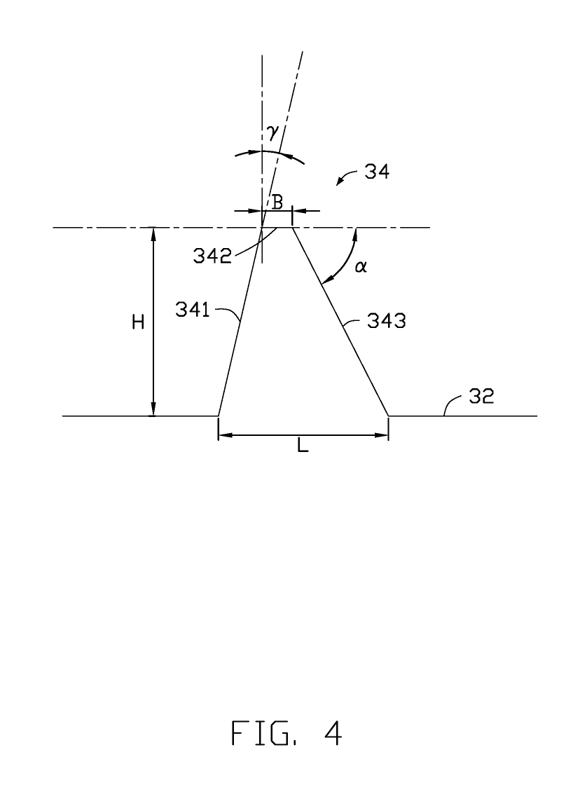

FIG. 4 is a first embodiment of the cutter teeth wherein each of the cutter teeth 34 includes a front cutter tooth surface 341, a blade edge 342, and a rear cutter tooth surface 343 connected in sequence. The front cutter tooth surface 341 and the rear cutter tooth surface 343 are coupled to the main body 32. The blade edge 342 is coupled between the front cutter tooth surface 341 and the rear cutter tooth surface 343 and is opposite to the main body 32 and is adapted for cutting a workpiece.

In one embodiment, a cutter tooth height H between the blade edge 342 and the main body 32 is between 0.001 millimeters and 0.5 millimeters.

In one embodiment, a blade width B of the blade edge 342 is between 0 and 0.1 millimeter.

In one embodiment, a cutter tooth width L between the front cutter tooth surface 341 and the rear cutter tooth surface 343 on the main body 32 is between 0.001 and 1.0 millimeter.

In one embodiment, an anterior angle γ of the front cutter tooth surface 341 relative to a normal plane of the main body 32 is between −40 degrees and 20 degrees.

In one embodiment, a posterior angle α of the rear cutter tooth surface 343 relative to a tangent plane of the blade edge 342 parallel to a tangent plane of the main body 32 is between 0 degrees and 90 degrees.

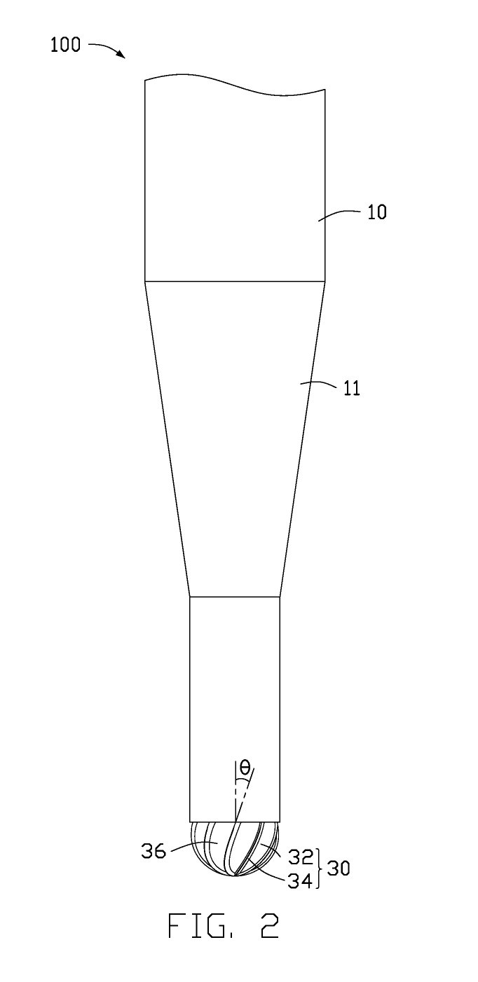

In one embodiment, the cutter teeth 34 are helically arranged on the main body 32. The cutter teeth 34 may be left-helix oriented, right-helix oriented, or a combination of left and right-helix oriented. A helical angle θ of the cutter teeth 34 (shown in FIG. 2) relative to the axis of the cutter bar 10 is between 0 degrees and 90 degrees.

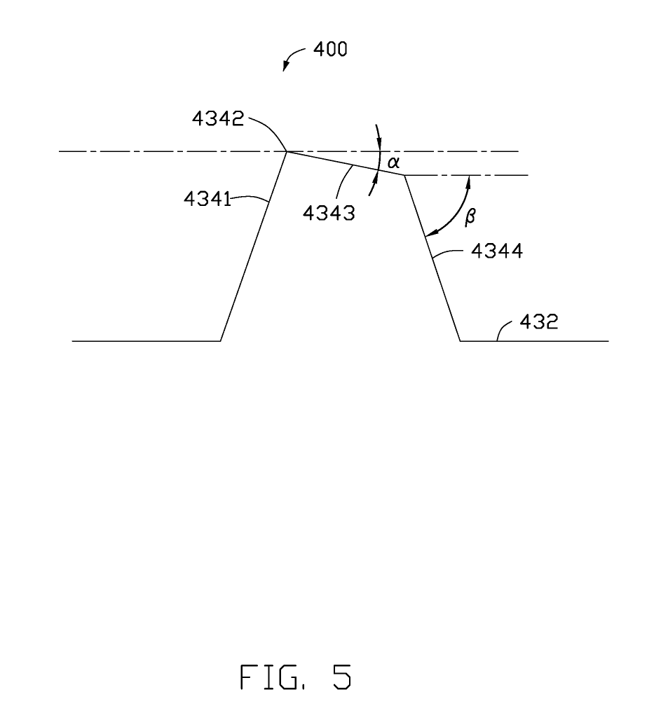

FIG. 5 shows a second embodiment of a ball cutter 400. A difference between the second embodiment and the first embodiment is that the cutter teeth 434 of the ball cutter 400 include a front cutter tooth surface 4341, a blade edge 4342, a rear cutter tooth surface 4343, and a second rear cutter tooth surface 4344 connected in sequence. The front cutter tooth surface 4341 and the second rear cutter tooth surface 4344 are coupled to the main body 432. A second posterior angle β of the second rear cutter tooth surface 4344 relative to a tangent plane of the blade edge 4342 parallel to a tangent plane of the main body 432 is between 0 degrees and 90 degrees. The posterior angle α is between 0 degrees and 90 degrees.

The ball cutter 100/400 as described above include the main body 32/432 mounting the plurality of cutter teeth 34/434. The quantity of the plurality of cutter teeth 34/434 is equal to a positive integer in a range between 8 and D*15. D is equal to the diameter of the main body 32 in millimeters. Thus, the ball cutter 100/400 can precisely process a workpiece such as graphite, ceramic, or other hard material, thereby enhancing a feed rate and an efficiency of processing workpieces. Furthermore, a life of the ball cutter 100/400 is extended.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A ball cutter comprising:
a cutter bar; and
a cutter head having one end mounted to the cutter bar, the cutter head comprising:
a main body; and
a plurality of cutter teeth mounted on the main body, a quantity of the plurality of cutter teeth equal to a positive integer within a range from 8 to D*15, wherein D is equal to a diameter of the main body of the cutter head in millimeters.

2. The ball cutter of claim 1, wherein:
the main body is hemispherical and comprises a hemispherical peripheral wall and a planar end wall;
the planar end wall is mounted to an end of the cutter bar;
an apex of the hemispherical peripheral wall is on an axis of the cutter bar;
each of the plurality of cutter teeth is mounted on the hemispherical peripheral wall.

3. The ball cutter of claim 2, wherein each of the plurality of cutter teeth has a first end at the apex of the hemispherical peripheral wall and a second end at a junction of the hemispherical peripheral wall and the planar end wall.

4. The ball cutter of claim 1, wherein the cutter head is made of diamond, cubic boron nitride, or ceramic.

5. The ball cutter of claim 1, wherein:
each of the plurality of cutter teeth comprises a blade edge; and
a shortest distance between the blade edge and the main body is between 0.001 and 0.5 millimeters.

6. The ball cutter of claim 5, wherein a width of the blade edge is between 0 and 0.1 millimeters.

7. The ball cutter of claim 6, wherein:
each of the cutter teeth comprises a front cutter tooth surface; and
an anterior angle of the front cutter tooth surface relative to a normal plane of the main body is between −40 degrees and 20 degrees.

8. The ball cutter of claim 7, wherein:
each of the plurality of cutter teeth comprises a rear cutter tooth surface; and
a posterior angle of the rear cutter tooth surface relative to a tangent plane of the blade edge parallel to tangent plane of the main body is between 0 degrees and 90 degrees.

9. The ball cutter of claim 8, wherein every two adjacent cutter teeth cooperatively define a groove, a width of the groove being between 0.01 and 2.0 millimeters.

10. The ball cutter of claim 9, wherein:
the front cutter tooth surface, the blade edge, and the rear cutter tooth surface are coupled in sequence;
each of the front cutter tooth surface and the rear cutter tooth surface is coupled to the main body;
the blade edge is coupled between the front cutter tooth surface and the rear cutter tooth surface and is opposite to the main body.

11. The ball cutter of claim 9, wherein:
each of the plurality of cutter teeth comprises a second cutter tooth surface;
the front cutter tooth surface, the blade edge, the rear cutter tooth surface, and the second rear cutter tooth surface are coupled in sequence;
each of the front cutter tooth surface and the second rear cutter tooth surface is coupled to the main body;
the blade edge is coupled between the front cutter tooth surface and the first rear cutter tooth surface and is opposite to the main body.
